(19) United States
(12) Patent Application Publication
(10) Pub. No.: US 2022/0361453 A1
(43) Pub. Date: Nov. 17, 2022

(54) BASKET MUZZLE FOR DOGS AND CATS

(71) Applicant: Luis Kishon, West Palm Beach, FL (US)

(72) Inventor: Luis Kishon, West Palm Beach, FL (US)

(21) Appl. No.: 17/577,013

(22) Filed: Jan. 17, 2022

Related U.S. Application Data
(60) Provisional application No. 63/187,763, filed on May 12, 2021.

(51) Int. Cl. A01K 25/00

(52) U.S. Cl. CPC A01K 25/00

(57) ABSTRACT

A muzzle for brachycephalic breeds of dogs and cats that includes a muzzle body and a pair of straps that extends from the left and right sides of the mask body respectfully. Free ends of the straps can include a fastening member for securing the muzzle to a head of the dogs or cats. The muzzle body can cover most of the face of the pet, wherein a periphery of the muzzle body can extend over the forehead and around the ears of the pet. The muzzle body can be made from plastic wires arranged in a grid-like fashion such that a void is formed between the interlocking plastic wires. There can be enough space between the muzzle body and the face of the pet, such that the pet can wide open its mouth.

### CROSS-REFERENCE TO RELATED APPLICATIONS

This application claims priority from the U.S. provisional patent application Ser. No. 63/187,763, filed on May 12, 2021, which is incorporated herein by reference in its entirety.

### FIELD OF INVENTION

The present invention relates to a basket muzzle for dogs and cats, and more particularly, the present invention relates to a basket muzzle for brachycephalic breeds of dogs and cats.

### BACKGROUND

Muzzles are safety tools that are used for aggressive dogs that have bitten or can bite another animal or a person. Muzzles are also available for cats to calm down and prevent the cats from biting anyone. A muzzle is a covering or a fastening for a mouth of an animal that prevents the animal from biting. Three types of muzzles are commonly used i.e., the Basket muzzle, soft sleeve muzzle, and short-snout muzzle. A basket muzzle is commonly used for outdoor activities. The soft sleeve muzzle is generally used for short-term use. The short-snout muzzle is used for flat-face dogs. For cats, the choice of muzzles is rather limited to a kind of mask made from a breathable mesh material that covers the eyes and the mouth of the cat, leaving the nose free, and the muzzle secured to the head using a hook and loop fastener.

Brachycephalic dogs and cats are those that have a skull width greater than their length, which gives them the appearance of possessing a flat nose. Brachycephalic dogs and cats are overly sensitive to high temperatures. Examples of brachycephalic dog breeds include Boxer, Bulldog, French Bulldog, Pekingese, Shih Tzu, Pug, and Shar-Pei. Examples of brachycephalic cats include Persian, Himalayan, and Burmese cats. In the United States, the Brachycephalic breeds of dogs and cats are quite popular among pet lovers.

Muzzles are a safety tool, however, improper use of known muzzles or use of improper muzzles in both dogs and cats can become quite painful. In situations involving painful or stress-causing procedures, methods ranging from light sedation to deep anesthesia are often required. Known muzzles for both the dogs and cats suffer from several drawbacks and limitations, the major drawback of the cat's muzzle is blocking the eyes of the cats which makes them more skittish or jumpy. The muzzles used for dogs can make it difficult for the dogs to take a deep breath i.e., gasping. This problem can escalate when the dog is taken to a veterinary clinic or when the dog is exposed to high temperatures or high stress. Moreover, the dogs may deny physical activities while wearing the muzzles because they cannot breathe properly. However, it may become essential to use a muzzle for aggressive dogs when taken for a walk or in a public place for the safety of others. Similarly, the use of muzzles in cats can become necessary in a public place or a veterinary clinic. Muzzles that do not fit properly can cause additional discomfort to the dogs or cats and can further worsen the condition.

Thus, a need is there for an improved design of muzzles for dogs and cats that allow the dogs and cats to open their mouth wide for gasping.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a muzzle for pets that allow the pets to open their mouth wide for gasping.

It is another object of the present invention that the muzzle can prevent the dog or cat from biting the others.

It is still another object of the present invention that the wearing of the muzzle by the dogs or the cats can be painless.

It is yet another object of the present invention that the muzzle does not hinder the vision of cats.

It is a further object of the present invention that the muzzle reduces the resistance of the pets to wearing the muzzle.

It is still a further object of the present invention that the muzzle causes no or insignificant discomfort.

It is yet a further object of the present invention that the muzzle can be collapsed for storage, packaging, and transport.

It is an additional object of the present invention that the muzzle can fit over the face easily.

In one aspect, disclosed is a muzzle that includes a muzzle body and a pair of straps i.e., a left strap and a right strap that extends from the left and right sides of the mask body respectfully. A third strap can also be provided that extends from the top of the mask body. Free ends of the pair of straps can include a fastening member that allows the free ends to be fastened together. Moreover, one or both of the straps can have a slide adjuster to adjust the effective length of the strap. The third strap can be coupled to either the left strap or the right strap, or the fastening member.

In one aspect, the muzzle body can cover an entire face of the pet, wherein a periphery of the muzzle body can extend over the forehead and around the ears of the pet. The cheeks of the face can be covered by the muzzle body. The profile of the muzzle body can correspond to the shape of the face of the pet. The muzzle body can be made from plastic wires arranged in a grid-like fashion such that a void is formed between the interlocking plastic wires. The voids can extend throughout the muzzle body. The size of the voids can be sufficiently large that does not hinder the vision of the pet, ventilation, and at the same time prevent the pet from biting. There can be enough space between the muzzle body and the face of the pet, such that the pet can wide open its mouth freely for gasping.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a muzzle for pets, according to an exemplary embodiment of the present invention.

FIG. 2 shows the muzzle on a dog, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

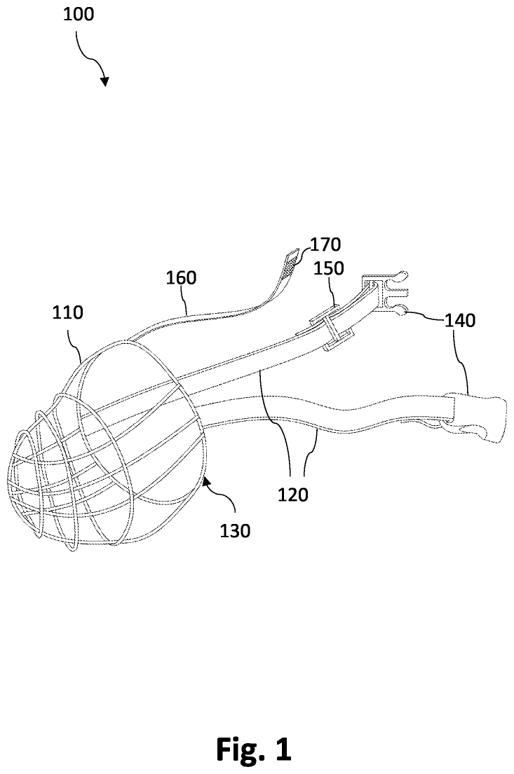

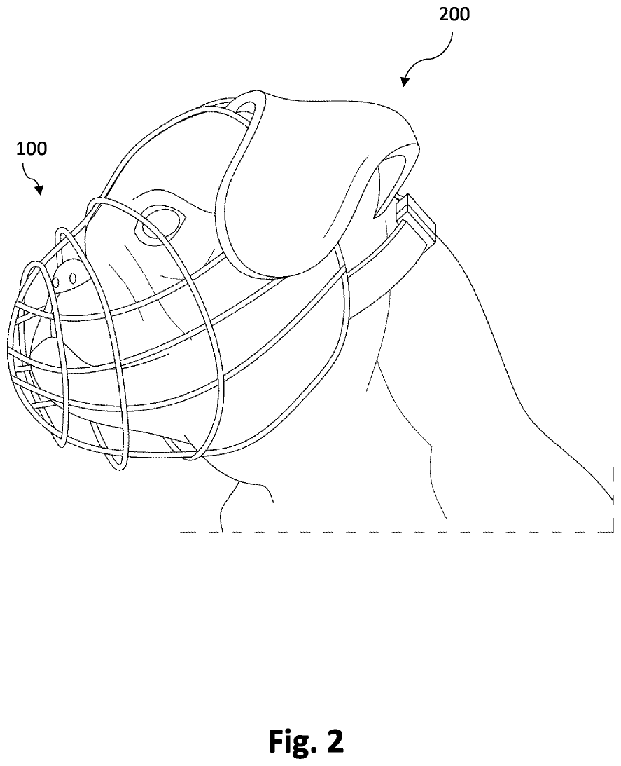

Disclosed is a muzzle of pets including dogs and cats that can encompass most of the face of a pet allowing the pets to freely wide open their mouth for gasping. Referring to FIG. 1 which shows an exemplary embodiment of the muzzle 100 that includes a muzzle body 110 and a pair of straps 120. The muzzle body 110 can cover the face of the pet such that to prevent the pet from biting another animal or person. The muzzle body can encompass most of the face of the pet, as shown in FIG. 2, extending over the forehead, and covering the cheeks of the face. The muzzle body 110 can follow the contours of the face of the pet i.e., of a dog or cat, such that a pet can open its mouth freely and widely for deep breathing or gasping. There could be sufficient space between the face and the muzzle body allowing free movement of the jaws of the pet. A periphery 130 of the muzzle body 110 can extend over the forehead and around the two ears of the pet. The shape of the muzzle body 110 can accommodate small variations in the shapes and sizes of the head of the dogs or cats, such that standard sizes of the muzzle can comfortably fit. The periphery 130 of the muzzle body 110 can fit over the face such that to prevent the muzzle body to squeeze over the face.

The muzzle body 110 can be in the form of a mesh made from plastic wires arranged in a grid-like fashion such that a void is formed between the interlocking plastic wires. The voids can extend throughout the muzzle body. It is understood that the voids can be square, round, triangular, rectangular, or polygonal with five or more sides, and such shape of the voids is within the scope of the present invention. A portion of the mask body that lies in front of the eyes of the pet can have broad voids such that not to hinder the vision of the pet.

In one exemplary embodiment, it is also envisioned that the mask body can be made in two halves that can connect through hinge joints. This may allow the two halves of the mask body to collapse for storage and unfolded for putting on the pet. Such a feature of the mask body can facilitate the display, storage, and transportation of the muzzle.

Again, referring to FIG. 1 which shows a pair of straps 120 i.e., a left strap and a right strap that extends rearwards from a left side and a right side of the mask body. The pair of straps 120 can be coupled near a periphery 130 of the muzzle body 110 through suitable fastening means, such as hook, bonding, and the like. Free ends of the pair of straps can have a fastening member 140 for coupling the free ends of the pair of straps. The pair of straps and the fastening member can allow securing the muzzle to the head of the pet, wherein the muzzle body can be positioned over the face and the two straps 140 can wrap over the head to reach the back of the head and the free ends can then be coupled to each other through the fastening member 140. The fastening member can be a hook and loop fastener, a fast release buckle, and the like. FIG. 1 shows two parts of the fast release buckle coupled at the free ends of the pair of straps. FIG. 2 shows the muzzle 100 secured to a head of a dog 200. One or both of the straps 120 can have a slide adjuster 150 for increasing or decreasing the effective length of the strap. A third strap 160 can also be provided that extends from the top of the muzzle body and rearwards and can further stabilize the muzzle on the head of the pet. The free end of the third strap 160 can be coupled to either of the pair of straps 120. Alternatively, the free end of the third strap 160 can be coupled to one part of the fastening member 140r. Still, alternatively, the fastening member can be adapted for joining the three straps. Also, the free end of the third strap 160 can have a fastener, such as a hook and a loop fastener 170, wherein the free end of the third strap 160 can loop around the fastened pair of straps 120 and secured by the hook and a loop fastener 170.

In certain embodiments, the muzzle can be made in various colors and sizes. It is understood that the embodiments have been described for dogs and cats, however, the disclosed muzzle can be used for other pets without departing from the scope of the present invention. Preferably, the disclosed muzzle can be used for brachycephalic breeds of dogs and cats. The muzzle can be made from plastic material, such as polystyrene. The muzzle can be produced by a suitable process, such as injection molding. The disclosed muzzle has the benefit and the appeal of the easiness of putting on the pet as well as the easiness of removal. Since the disclosed muzzle does not interfere with the free-breathing and panting of the dog or cat, the muzzle can be used on the pet at the moment the pet goes outside for a walk but avoids either any act of aggressiveness towards passing by people or either to grab whatever object from the floor thus also avoiding the risk of intoxication or the ingest of a foreign body, which is a very common situation among dogs and cats.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A muzzle for a pet, the muzzle comprising:
a muzzle body configured to cover a face of the pet, wherein a periphery of the muzzle body extends over a forehead and around ears of the pet, wherein the muzzle body by covering a mouth of the pet is configured to prevent the pet from biting, wherein the muzzle body is configured to allow the pet wearing the muzzle to wide open the mouth; and
a pair of straps that extends from the mesh body and are configured to secure the muzzle to a head of the pet.

2. The muzzle according to claim 1, wherein the muzzle body is in a form of a mesh made of plastic wires arranged in a grid-like fashion such that a void is formed between interlocking plastic wires.

3. The muzzle according to claim 1, wherein the muzzle further comprises a third strap that extends from a top of the muzzle body and is configured to stabilize the muzzle over the head of the pet.

4. The muzzle according to claim 3, wherein the muzzle further comprises a fastening member having a male member and a female member, the male member coupled to a free end of a left strap of the pair of straps, the female member coupled to a right strap of the pair of straps, wherein the male member is configured to fasten to the female member for coupling free ends of the pair of straps.

5. The muzzle according to claim 4, wherein the fastening member is a hook and loop fastener.

6. The muzzle according to claim 4, wherein the fastening member is a snap-fit buckle.

7. The muzzle according to claim 1, wherein a portion of the muzzle body configured to be positioned in front of eyes of the pet wearing the muzzle, is broader such that do not hinder a vision of the pet.
